(19) United States
(12) Patent Application Publication
(10) Pub. No.: US 2008/0133281 A1
(43) Pub. Date: Jun. 5, 2008

(54) Method and System for Creating Rental Vehicle Reservations from Facsimile Communications

(75) Inventors: Jeremy W. Bolt, Ballwin, MO (US); Jerry L. Bradshaw, Swansea, IL (US); Russell E. Dittmar, St. Charles, MO (US); M. Derik Reiser, Maryville, IL (US); Chris J. Tellegen, Guildford (GB)

Correspondence Address: THOMPSON COBURN, LLP, ONE US BANK PLAZA, SUITE 3500, ST LOUIS, MO, 63101, US

(73) Assignee: THE CRAWFORD GROUP, INC., St. Louis, MO (US)

(21) Appl. No.: 11/565,197

(22) Filed: Nov. 30, 2006

(51) Int. Cl. G06Q 10/00

(52) U.S. Cl. 705/5

(57) ABSTRACT

A system and method are disclosed for creating vehicle rental reservations from electronic communications. In an embodiment wherein the electronic communications comprise facsimile communications, optical character recognition (OCR) is employed to automatically extract the relevant data for a rental vehicle reservation from the received facsimiles. This automatically extracted reservation data can then be automatically loaded into the reservation computer system of a rental vehicle service provider to thereby book a rental vehicle reservation therewith.

### CROSS REFERENCE TO RELATED PATENT APPLICATIONS

This application is related to the following pending U.S. patent applications: (1) U.S. patent application Ser. No. 09/641,820, filed Aug. 18, 2000, (2) U.S. patent application Ser. No. 09/694,050, filed Oct. 20, 2000, (3) U.S. patent application Ser. No. 10/028,073, filed Dec. 26, 2001, and published as U.S. patent application publication 2003/0125992, (4) U.S. patent application Ser. No. 10/343,576, filed Jan. 31, 2003 (which is a national phase of PCT patent application serial number PCT/US01/51437, filed Oct. 19, 2001), and published as U.S. patent application publication 2005/0021378, (5) U.S. patent application Ser. No. 10/865,116, filed Jun. 10, 2004, and published as U.S. patent application publication 2005/0091087, and (6) U.S. patent application Ser. No. 11/550,614 filed Oct. 18, 2007, the entire disclosures of each of which are incorporated herein by reference.

### FIELD OF THE INVENTION

This invention relates generally to the field of booking rental vehicle reservations and, more particularly, to a system and method for automating the manner by which electronic communications such as facsimile (hereinafter “fax”) communications are used to book such reservations.

### BACKGROUND AND SUMMARY OF THE INVENTION

While a significant portion of the vehicle rental business involves rental for leisure, business travel, etc., another significant business relationship has developed with insurance companies and the like in what has been termed as “the replacement car rental service business.” In this business, a vehicle insurance company may have many thousands of policyholders involved in accidents and other dislocations of use, requiring that a vehicle be rented, as a replacement, for that customer's use while his own vehicle is repaired or replaced. Thus, for this business segment, a multi-tiered business organization such as a vehicle insurance company represents a significant customer for frequent vehicle rental services on a large scale. Some vehicle insurance companies communicate their reservations for replacement rentals to a rental vehicle service provider via fax. Typically, when a fax is received, the reservation information is manually entered into a reservation computer system by an employee of the rental vehicle service provider in order to complete the rental vehicle transaction. This manual data entry consumes time and money.

In order to streamline the process of receiving faxes from external purchasers for reservations and inputting the reservation data therein into a reservation computer system, the present invention is directed toward a system that employs a fax processing system to automatically extract relevant reservation data from faxes. Preferably, the fax processing system utilizes optical character recognition (“OCR”) technology to automatically extract rental vehicle reservation data from the received fax images. This automatically extracted reservation data can then be readily loaded into the rental vehicle service provider's reservation computer system without requiring extensive manual data entry efforts by personnel of the rental vehicle service provider.

According to another aspect of the invention, the fax image and extracted data can be sorted into predetermined categories and stored in an appropriate queue based on their assigned categories. In a further inventive aspect, software can display the fax image and the extracted data to a user, whereupon the user can choose whether or not the extracted reservation data is to be loaded into the reservation computer system. In still another inventive aspect, a user can select from the queue a fax image and extracted data for viewing. According to yet another inventive aspect, the software can allow the user to modify the extracted reservation data. Further still, the fax image can be stored in a database for subsequent searching and retrieval.

Moreover, in embodiments wherein the reservation computer system into which the fax processing system loads reservation data is an automated rental vehicle reservation management system such as the ones described in the above-referenced and incorporated related patent applications, the inventors herein note that the power of such an automated rental vehicle reservation management system is further enhanced by expanding the modes by which purchasers can create reservations with the system. That is, the same reservation computer network maintained by a rental vehicle service provider that can be used to connect with web-enabled purchasers via an Internet connected web portal can also be used to connect to fax-enabled purchasers via the fax processing system described herein. Such multiple paths into a rental vehicle service provider's reservation network provides great economy of scale when large volumes of reservation transactions are considered.

These and other features and advantages of the invention will be apparent to those having ordinary skill in the art upon a review of the description and figures herein.

### BRIEF DESCRIPTION OF THE DRAWINGS

FIG. 1 illustrates an exemplary system in accordance with a preferred embodiment of the present invention;

FIG. 2 illustrates the system of FIG. 1 with a preferred fax processing system depicted in greater detail;

FIG. 3 is a flowchart that depicts an exemplary flow for processing faxes to extract relevant reservation data therefrom;

FIG. 4 is a flowchart that depicts in greater detail how OCR is performed on faxes in accordance with a preferred embodiment of the present invention;

FIG. 5 is a flowchart that depicts step 406 of FIG. 4 in greater detail for an exemplary purchaser;

FIG. 6 is a flowchart that depicts how a user can efficiently book rental vehicle reservations with a reservation computer system using the reservation data extracted from a received fax;

FIGS. 7(a) and (b) depict exemplary screenshots for GUIs configured to interface the user with a plurality of categories of received faxes on a per-purchaser basis;

FIGS. 8(a) and (b) depict exemplary screenshots of GUIs configured to interface the user with a plurality of received faxes within a user-selected category;

FIGS. 9(a)-(e) depict exemplary screenshot GUIs configured to provide the user with the ability to automatically populate reservation data extracted from a received fax into a reservation computer system;

FIG. 10 depicts a first embodiment of an automated rental vehicle reservation management system that can be used as the reservation computer system for the present invention;

FIG. 11 depicts a second embodiment of an automated rental vehicle reservation management system that can be used as the reservation computer system for the present invention;

FIG. 12 is an exemplary screenshot of a GUI configured to allow the user to search a database for any received faxes that meet user-specified criteria;

FIG. 13 illustrates an exemplary system in accordance with another preferred embodiment of the present invention;

FIGS. 14(a) and (b) illustrate the system of FIG. 13 with a preferred electronic document processing system depicted in greater detail; and

FIG. 15 illustrates a system in accordance with another preferred embodiment of the present invention wherein both faxes and other electronic documents are automatically processed to create rental vehicle reservations.

### DETAILED DESCRIPTION OF THE PREFERRED EMBODIMENT

As noted above, a significant number of orders for rental vehicle reservations from purchasers of rental vehicle services are made by facsimile (fax) communication. A good example of a purchaser that may send high volumes of such faxes to a rental vehicle service provider is a business organization with a recurring need to book reservations on behalf of its employees or others (e.g., an insurance company that often books replacement rental vehicle reservation for insureds and claimants, a corporation whose employees (such as salespeople) often book rental vehicles for business travel, a travel agency, etc.).

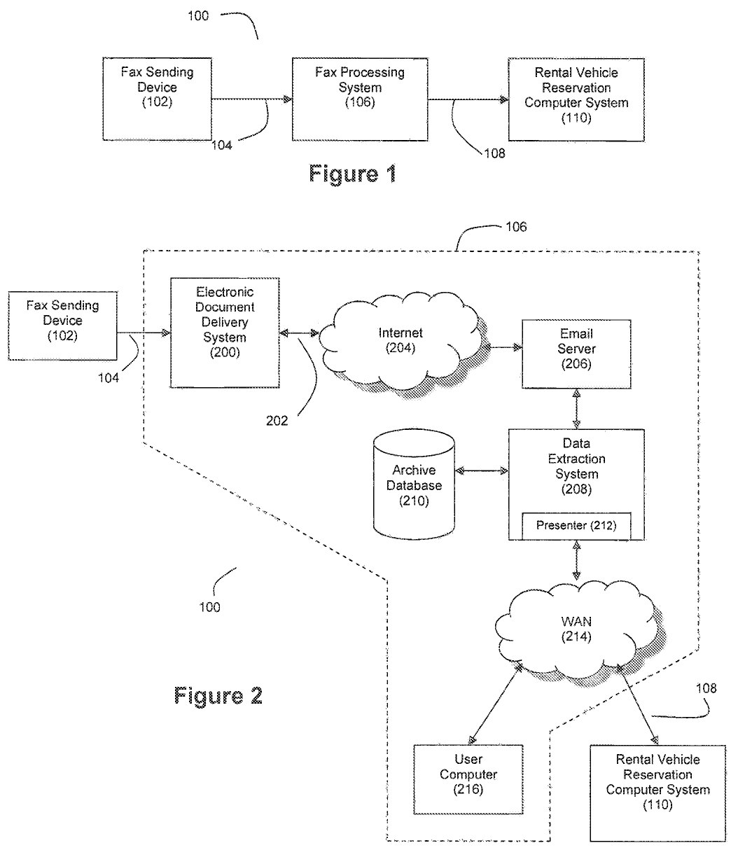

FIG. 1 illustrates an exemplary system 100 for increasing the automation by which such faxes are converted into rental vehicle reservations for storage and processing by a rental vehicle service provider's reservation computer system 110. System 100 preferably comprises a fax sending device 102 that is configured to send a fax communication 104 to a fax processing system 106. Fax sending device 102, which is preferably operated by a purchaser of rental vehicle services, can be embodied by any of a number of known and readily available devices that are configured to send faxes. For example, fax sending device 102 can be embodied by a fax machine that is configured to receive and scan a paper form and then transmit the scanned form as a fax 104 to a designated telephone/fax number. Similarly, fax sending device 102 can be embodied by a computer with fax sending software (preferably software that allows the purchaser to create a fax from electronic data stored on the computer rather than from a paper form). Fax processing system 106 is configured to convert the received fax data 104 into reservation data 108 that can be processed by the reservation computer system 110 and then communicate that reservation data 108 to the reservation computer system 110 for processing thereby. The reservation computer system 110 is preferably the ARMS® system (hereinafter the “ARMS system”) operated by Enterprise Rent-A-Car Company (hereinafter “Enterprise”), the details of which are described in the above-referenced and incorporated patent applications. However, it should be noted that other reservation computer systems can be employed in the practice of the present invention.

FIG. 2 illustrates a preferred embodiment of fax processing system 106. An electronic document delivery system 200 is preferably configured to receive fax data 104 from the purchaser and convert the received fax data 104 into an electronic image 202, preferably a portable document format (“PDF”) image. The resultant fax images 202 are then sent by the electronic document delivery system 200 via email (the fax image 202 being an attachment thereto) to an email server 206 (preferably over a network 204 such as the Internet). The electronic document delivery system 200 may employ any of a variety of known commercial software packages that are configured to convert incoming faxes to images and forward the same to an e-mail server 206, many of which are offered as services by third parties. A preferred example is Venali® in-bound eMessaging offered by Venali, Inc. of Coral Gables, Fla. It should be noted that the format for the electronic images need not be limited to PDF images; any standard or proprietary format for electronic imaging can be used, including but not limited to a tagged image format (“TIF”) or a bitmap (“BMP”), by way of example.

Email server 206 is in communication with a data extraction system 208. The data extraction system 208 receives the emails with fax images 202 from the email server 206. The data extraction system 208 preferably uses OCR technology to extract the rental vehicle reservation data from the fax images. When the format used for the fax images 202 is the PDF format, the data extraction system preferably converts the PDF fax images to a TIF format prior to performing OCR thereon. Through a presenter interface 212, a user of user computer 216 (preferably in communication with the presenter interface 212 via a network 214 such as wide area network (WAN)) can review the reservation data extracted by the data extraction system 208 and load that reservation data 108 into a rental vehicle reservation system 110 (preferably via the network 214 as shown). The user also preferably has the ability to modify any of the extracted reservation data before loading it into the reservation system 110 if changes thereto are needed. The data extraction system 208 also preferably stores both the fax images 202 and the extracted reservation data in an archive database 210 in case they need to be accessed at a later time. The data extraction system 208 may employ OCR technology that is available from any of several vendors, a preferred OCR technology for use with the invention being the Covus® package from FormScape Software, Ltd. of Hampshire, United Kingdom, which has been acquired by Bottomline Technologies of Portsmouth, N.H.

The user of user computer 216 is preferably an employee of a rental car company, although this need not be the case. For example, the user of user computer 216 may be the individual who sent the fax rental order 104, or another individual who is employed by the purchaser. It should also be noted that networks 204 and 214 can readily be the same network (for example, the Internet can be used for both networks 204 and 214; similarly a WAN can be used for both networks as could a Local Area Network (LAN)).

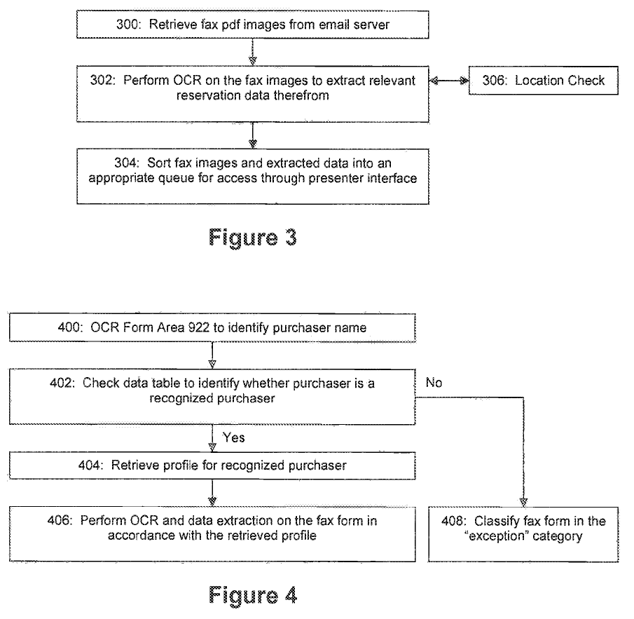

FIG. 3 depicts an exemplary processing flow for the manner in which the data extraction system 208 operates. At step 300, the data extraction system 208 retrieves the PDF fax images from email server 206. Next, at step 302, the data extraction system 208 performs OCR on the PDF fax images to extract the relevant reservation data therefrom. As part of this process, the PDF images are preferably converted to a TIF format. Also, at step 306, a check is performed on the message from the email server 206 to ensure that the message did in fact arrive from the email server 206 and that the message is not email spam. Then, at step 304, the data extraction system 208 preferably sorts the fax images (and the data extracted therefrom) into an appropriate queue for access by the user through the presenter interface 212. Faxes and extracted reservation data are preferably categorized into one or more reservation categories according to purchaser-specified and/or rental vehicle service provider-specified criteria. Queues associated with the different reservation categories then store the fax images and extracted data.

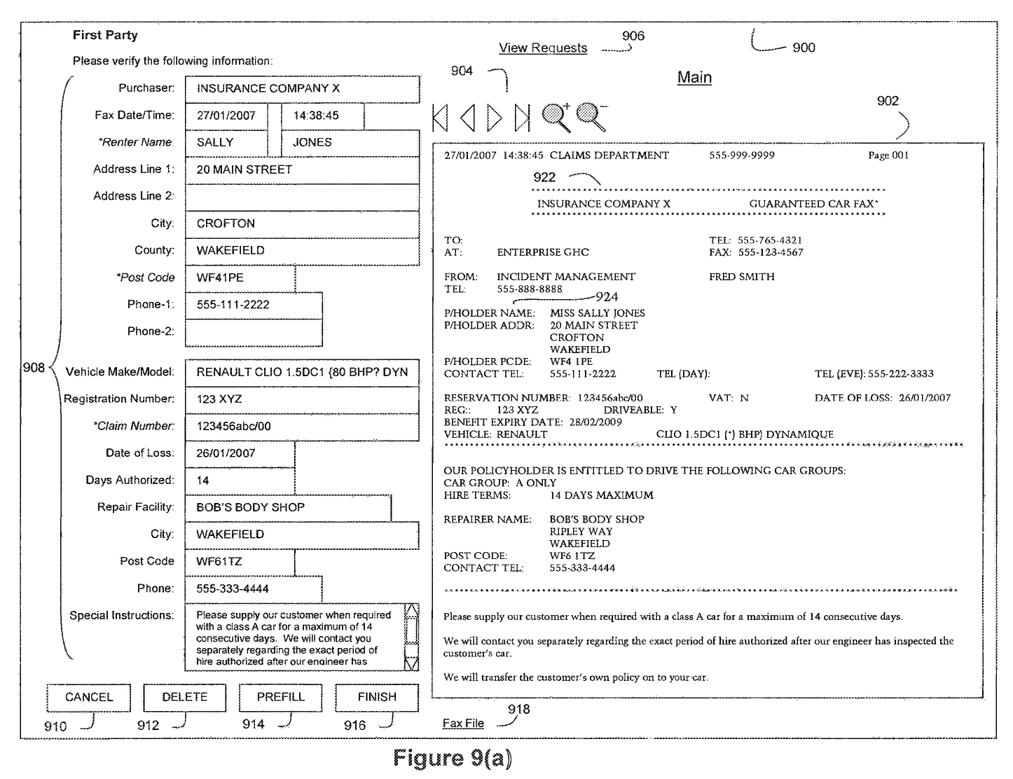

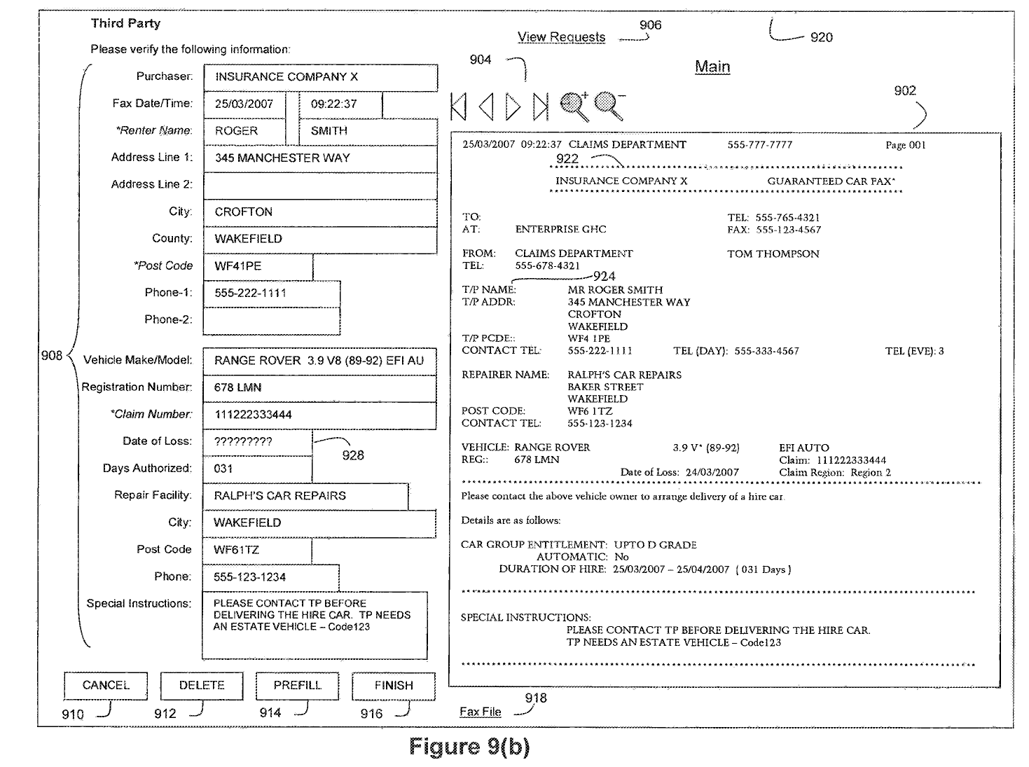

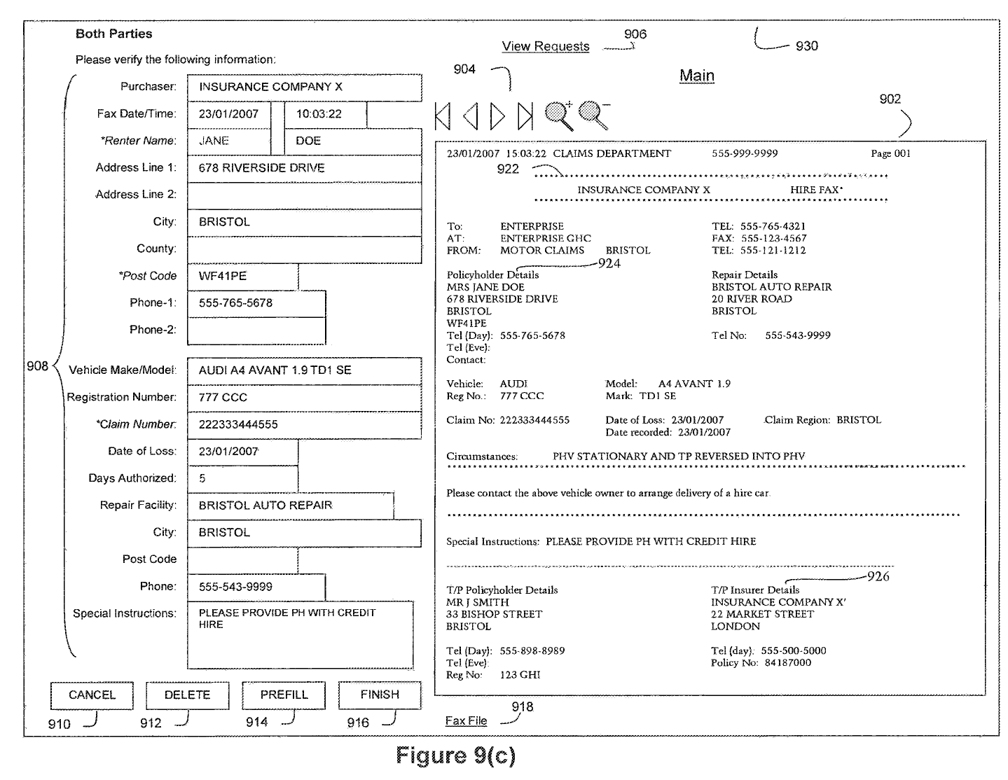

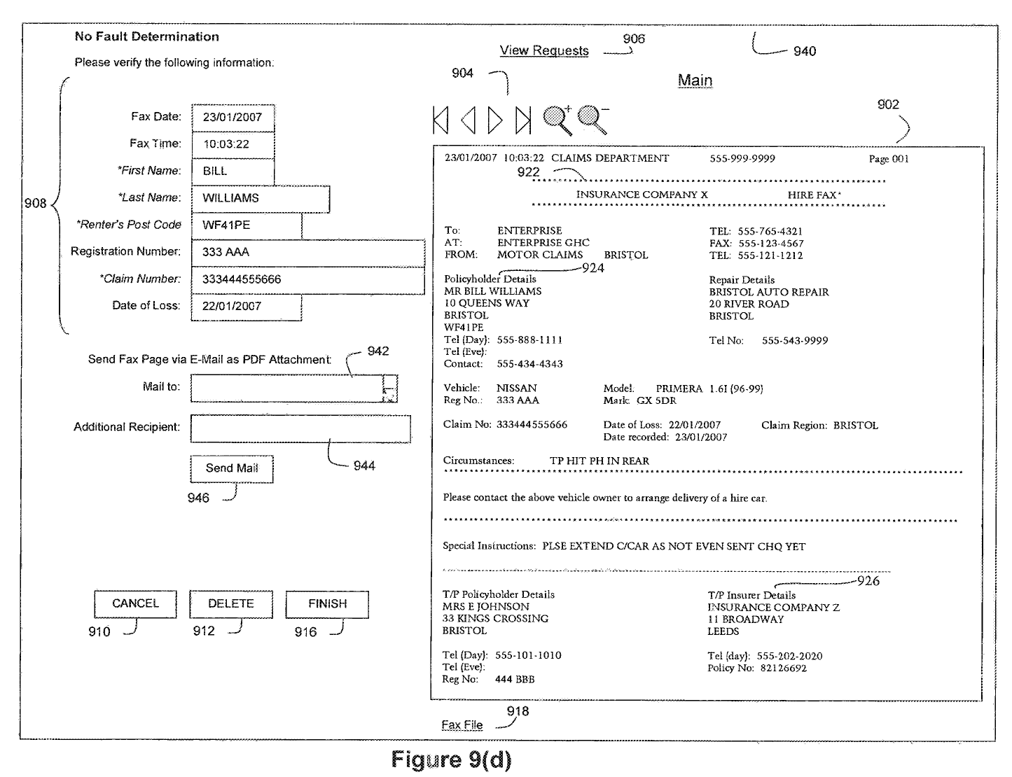

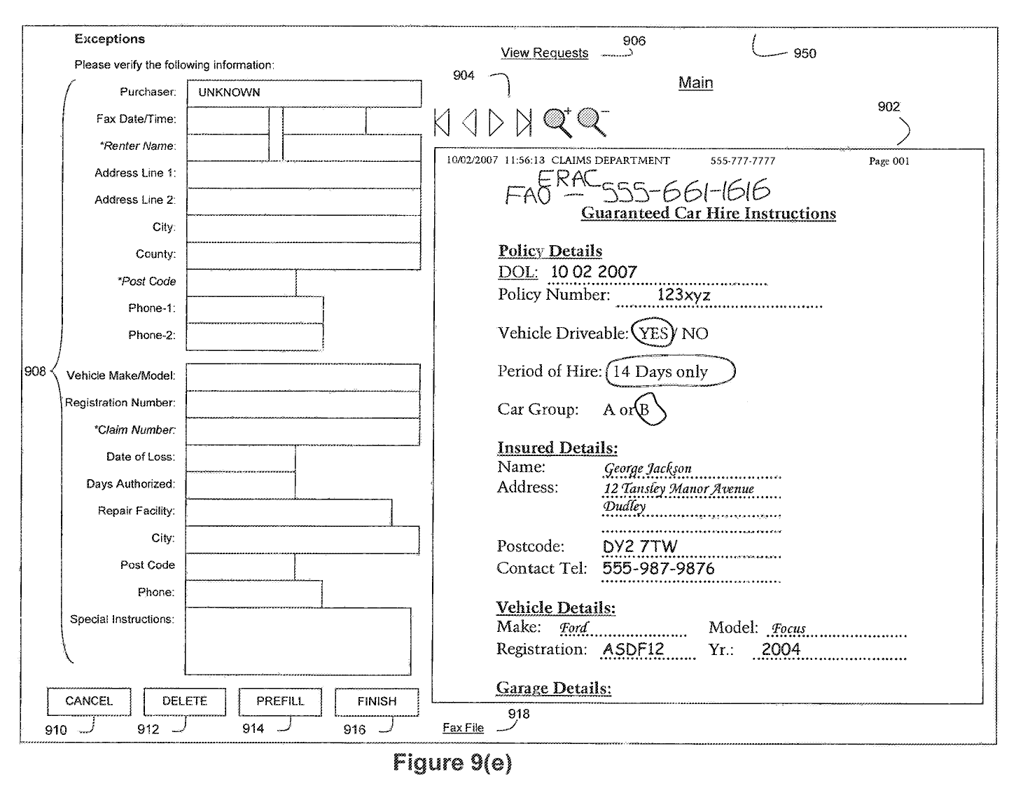

FIG. 4 depicts the process step 302 of FIG. 3 in greater detail. It should be noted that the fax forms utilized by the purchaser preferably have a format that is predefined and known to the data extraction system 208. Through the use of such a pre-defined form format, the data extraction system can readily categorize received faxes and extract reservation data as appropriate therefrom. At step 400, the data extraction system performs OCR on a predefined area of the fax image to identify the name of the purchaser. With reference to the fax images 902 shown in FIGS. 9(a)-(e), this predefined area is preferably an area 922 near the top center of the fax image. However, it should be noted that other areas of the fax form could readily be used. At step 402, the data extraction system preferably checks a data table to identify whether the text extracted from the predefined area 922 matches any registered purchasers (such registered purchasers being listed in the data table; a registered purchaser being a purchaser that is known by the system 208 and for which the system 208 is capable of parsing a received fax form). If no match is found to a purchaser in the data table, the fax is preferably categorized as an “exception” (step 408). However, if a match is found to a purchaser, then at step 404, the data extraction system preferably retrieves a fax processing profile for that purchaser.

Where multiple purchasers utilize faxes to book rental vehicle reservations in accordance with the preferred embodiment of the present invention, each purchaser may potentially utilize its own fax form for communicating reservation information to the rental vehicle service provider (although it is preferable that all purchasers utilize a common area on their respective fax forms to identify themselves to the data extraction system 208). To accommodate the different fax forms of the different purchasers, a specialized OCR methodology is preferably defined for each such purchaser and maintained in a profile by the data extraction system 208 for that purchaser. Once the appropriate purchaser-specific OCR processing profile has been retrieved, the data extraction system 208 then preferably performs OCR and data extraction on the fax image in accordance with the retrieved profile (step 406), thereby extracting the appropriate reservation data for loading into the reservation computer system 110. It should be noted that if all purchasers utilize a common fax form, step 404 can be omitted from the process because only a single OCR processing methodology would need to be used.

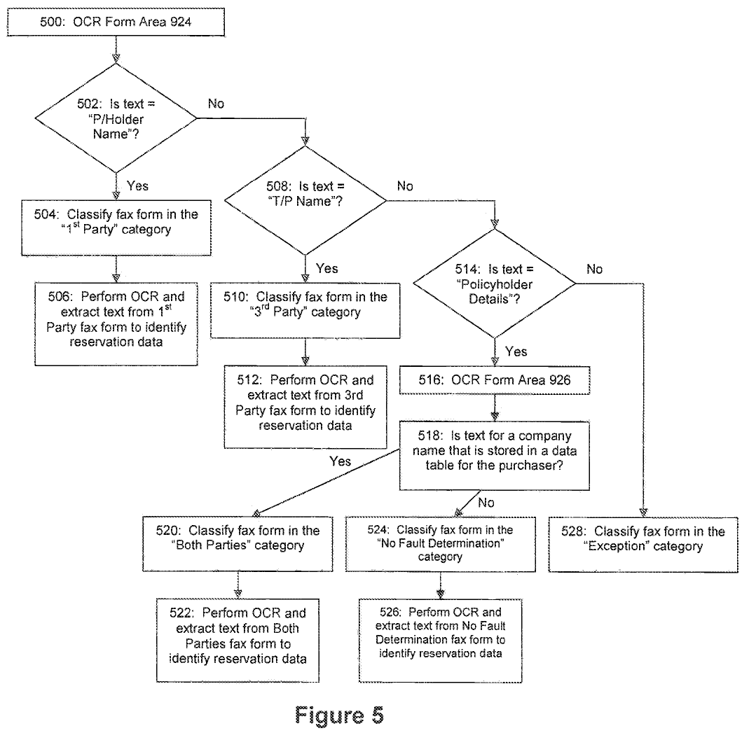

FIG. 5 depicts the processing flow for step 406 of FIG. 4 in greater detail for an exemplary purchaser-specific OCR processing profile. In situations where the purchaser is a business organization having multiple related and subsidiary companies (e.g., multiple insurance companies within a single umbrella organization), each of which having its own recurring need to book rental vehicle reservations, queues can be arranged around the business organization's needs as explained herein in connection with FIG. 5. In this example, the purchaser is a business organization in the insurance industry that is booking replacement rental vehicle reservations on behalf of its policyholders and claimants as part of the insurance claims that it handles. The purchaser business organization also has related and/or subsidiary business organizations doing the same thing for its policyholders and claimants.

In this environment, at step 500, the data extraction system 208 performs OCR on a predefined area 924 of the fax form in accordance with a profile defined for the purchaser. An example of such a fax form area 924 can be seen in the fax images 902 of FIGS. 9(a)-(d). If at step 502 a first specified predefined text string is found in area 924, then that fax is classified in the “First Party” category (step 504). Although other text strings can be used, a suitable text string for use with step 502 is the text string “P/Holder Name”. Then, at step 506, the data extraction system 208 performs OCR on the remaining pertinent areas of the fax and extracts reservation information therefrom. The “First Party” reservation category can be characterized as a reservation where the renter is an insurance policyholder with the purchaser.

If at step 502 a match is not found to the first text string, then at step 508 a second specified predefined text string is compared to the text extracted from area 924. If a match between the extracted text and the second predefined text string is found, then at step 510 the fax is classified in the “Third Party” category. Although other text strings can be used, a suitable text string for use with step 508 is the text string “T/P Name”. Then, at step 512, the data extraction system 208 performs OCR on the remaining pertinent areas of the fax and extracts reservation information therefrom. The “Third Party” reservation category can be characterized as a reservation where the renter is a claimant against an insurance policy held by a policyholder of the purchaser.

If at step 508 a match is not found to the second text string, then at step 514 a third specified predefined text string is compared to the text extracted from area 924. If a match between the extracted text and the third predefined text string is found, then at step 516 another area 926 of the fax form is scanned with OCR technology. Although other text strings can be used, a suitable text string for use with step 514 is the text string “Policyholder Details”. An example of a suitable area 926 within a fax image can be found in the fax image 902 shown in FIGS. 9(c) and (d). At this point, the data extraction system 208 is seeking to identify whether the third party's insurance company is the same (or affiliated with) the first party's insurance company. To achieve this, at step 518, the data extraction system 208 checks a data table maintained for that purchaser to identify whether the text extracted from area 926 matches any of the names of the purchaser's related/subsidiary companies. If the text from area 926 matches a company name in the data table, then the fax is classified in the “Both Parties” reservation category (step 520). Then, at step 522, the data extraction system 208 performs OCR on the remaining pertinent areas of the fax and extracts reservation information therefrom. The “Both Parties” reservation category can be characterized as a reservation for a renter in a situation where the purchaser represents both parties to the accident/damage that is the subject of the insurance claim. At this point, there may not have been any determination as to which insurance company is to pay for the rental corresponding to the reservation. If the text from area 926 does not match a company name in the data table, then the fax is classified in the “No Fault Determination” reservation category (step 524). Then, at step 526, the data extraction system 208 performs OCR on the remaining pertinent areas of the fax and extracts reservation information therefrom. The “No Fault Determination” reservation category can be characterized as a reservation for which no determination has been made as to who will be paying for the rental corresponding to the reservation, but it is known that one of the parties is a policyholder with the purchaser (or an affiliate/subsidiary of the purchaser) and that the other party is not a policyholder of the purchaser (or an affiliate/subsidiary of the purchaser).

In the event that step 514 results in the text extracted from area 924 also not matching the third text string, then that fax is preferably classified in the “Exception” category (step 528), to be process as explained below.

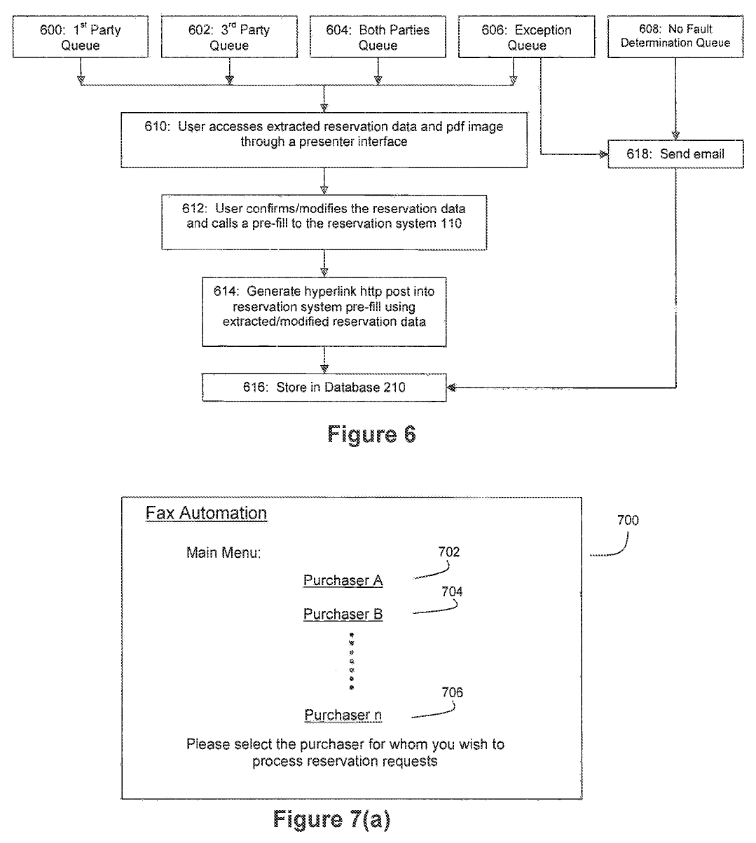

Once a fax has been categorized and automatically sorted by the data extraction system 208 into an appropriate queue based on its categorization, that fax is now ready for processing by a user to book a reservation with the reservation computer system 110. FIG. 6 depicts an exemplary processing flow for user interaction with the presenter interface 212 to book rental vehicle reservations with the reservation computer system 110. Continuing from the example of FIG. 5, at the start of this flow, various faxes and the data extracted therefrom are queued in a First Party queue 600, a Third Party queue 602, a Both Parties queue 604, an Exception queue 606, and a No Fault Determination queue 608.

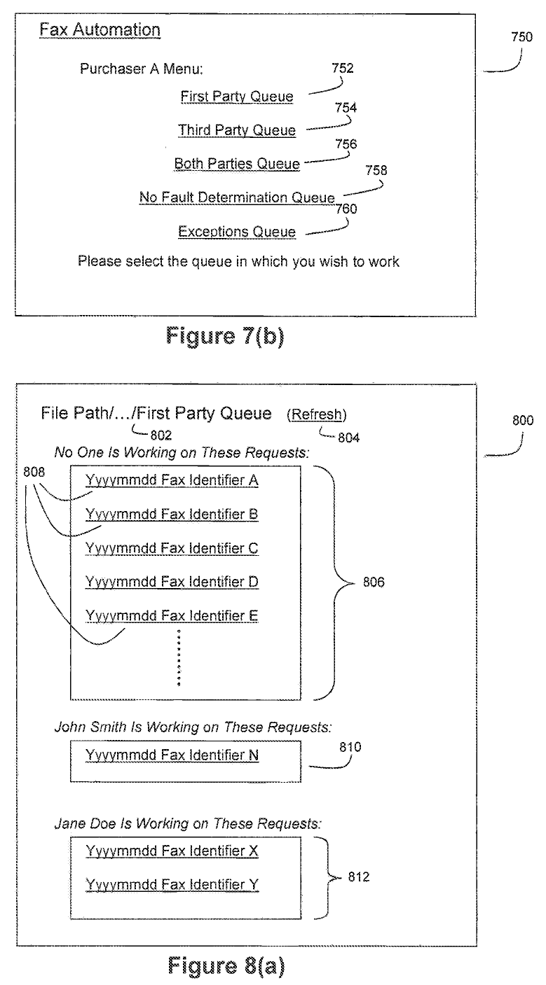

Next, at step 610, a user of the user computer 216 accesses the faxes and extracted data in each of these queues via the presenter interface 212. Through presenter interface 212, various GUIs can be accessed for display on the user computer 216. An example of such a GUI is shown in FIG. 7(a). The GUI 700 of FIG. 7(a) is configured to list the purchasers for whom the user can process reservation requests. Each purchaser is preferably listed as a selectable link (e.g., links 702, 704, 706, etc.).

Upon selection of one of the listed purchasers in GUI 700, the GUI 750 of FIG. 7(b) is preferably displayed. The GUI 750 of FIG. 7(b) is configured to list the available queues in which the user can work for the selected purchaser. Preferably, the queues are listed as a plurality of selectable links (e.g., links 752, 754, 756, 758 and 760. In the example of FIG. 7(b), the queues for Purchaser A have been arranged as a First Party queue (accessed via link 752), a Third Party queue (accessed via link 754), a Both Parties queue (accessed via link 756), a No Fault Determination queue (accessed via link 758) and an Exceptions queue (accessed via link 760).

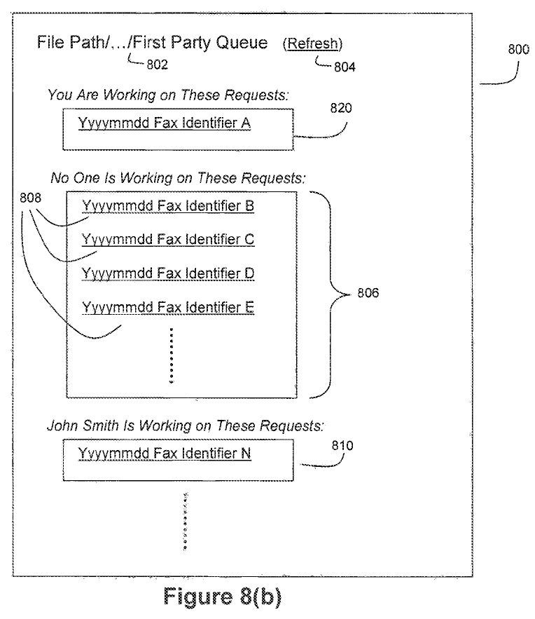

Upon user selection of one of these links in GUI 750, a second GUI such as the one in FIGS. 8(a) and (b) is shown. The GUI 800 of FIGS. 8(a) and (b) lists the faxes available for processing within the selected queue. In the example of FIGS. 8(a) and (b), the selected queue is the First Party queue, as shown by the file path notation 802. GUI 800 preferably sorts the faxes within the selected queue based on whether any users of the user computers 216 (preferably system 100 employs multiple user computers 216 to balance the fax processing workload) are or have begun working on those faxes. Thus, section 806 of GUI 800 lists a plurality of faxes that no users are currently working on. Each fax is preferably listed as a selectable link 808, wherein user selection of a link 808 is effective to display the GUIs shown in FIGS. 9(a)-(e). Section 810 of GUI 800 lists each fax that another user is currently working on, while section 812 lists each fax that yet another user is currently working on. By organizing the faxes within each queue in this manner, the system can permit only one user to view a fax image at a time to thereby prevent multiple users from working on the same request. The refresh link 804 can also be selected by the user to update GUI 800 to list any additional faxes that have recently been received and processed and/or to reflect any actions taken by other users within the queue. If the user has begun work on any of the faxes in section 806, then the next time that GUI 800 is shown to the user, it will preferably include a section 820 that lists each fax that the user is working on, as shown in FIG. 8(b).

Upon user selection of one of the links 808 in section 806, the GUI 900 of FIG. 9(a) is preferably displayed. Using GUI 900 (or, for the other reservation categories, the GUIs of FIGS. 9(b), (c) and (e)), the user can confirm and/or modify the extracted reservation data and automatically load (or “pre-fill”) that reservation data into the reservation computer system 110 (step 612 in FIG. 6).

The GUI 900 of FIG. 9(a) is configured with one section dedicated to displaying an image of the fax and another section dedicated for displaying (and possible data entry) of text extracted from the fax by system 208 corresponding to reservation data. Preferably, GUI 900 displays an image of the pertinent fax in section 902. Preferably, the fax image displayed in section 902 is a TIF image, but this need not be the case. Using image manipulation toolbar 904, the user can skip to the next, previous, first or last page for the displayed fax (if the fax is a multi-page fax), and can also zoom in or out on the displayed fax image. To return to GUI 800, the user can select link 906. Section 908 preferably comprises a plurality of data fields into which the reservation data extracted from the fax shown in section 902 is automatically populated by the data extraction system 208. By comparing the extracted text that has been automatically populated into the fields of section 908 with the fax image itself, the user can confirm whether the data extraction process has appropriately extracted the pertinent reservation information from the fax. If any changes need to be made to the extracted reservation data, the user can enter such changes in the appropriate fields of section 908. It should be noted that in the running example herein, the reservations are for replacement rental vehicle reservations arising as a result of an insurance claim. It is preferred that the reservation computer system 110 capture a significantly greater amount of information for such reservations than it would for a conventional retail reservations (such as reservations for leisure travelers who may need to rent a car to drive from an airport to their hotel). Beyond the minimal reservation information of renter name and reservation time period, the reservation data in section 908 preferably includes details about the renter's ordinary vehicle that is undergoing repairs, the repair facility where that ordinary vehicle is undergoing repairs, and a claim number that identifies the insurance claim that the reservation is to be applied against. By including such information in its reservation, the rental vehicle service provider and the purchaser can effectively manage replacement rental vehicles throughout the rental process (from the booking stage and beyond including the stages of opening a rental ticket as the renter picks up his/her replacement rental vehicle, extending the reservation as appropriate (e.g., when the repairs to the renter's ordinary vehicle are delayed), and closing a rental ticket when the renter returns his/her replacement rental vehicle), as described in the above-referenced and incorporated patent applications.

Once the user is satisfied that the correct information is listed in the fields of section 908, he/she can then select the prefill button 914. Upon selection of the pre-fill button 914, the reservation data in section 908 is automatically posted into the reservation computer system 110 (step 614 of FIG. 6).

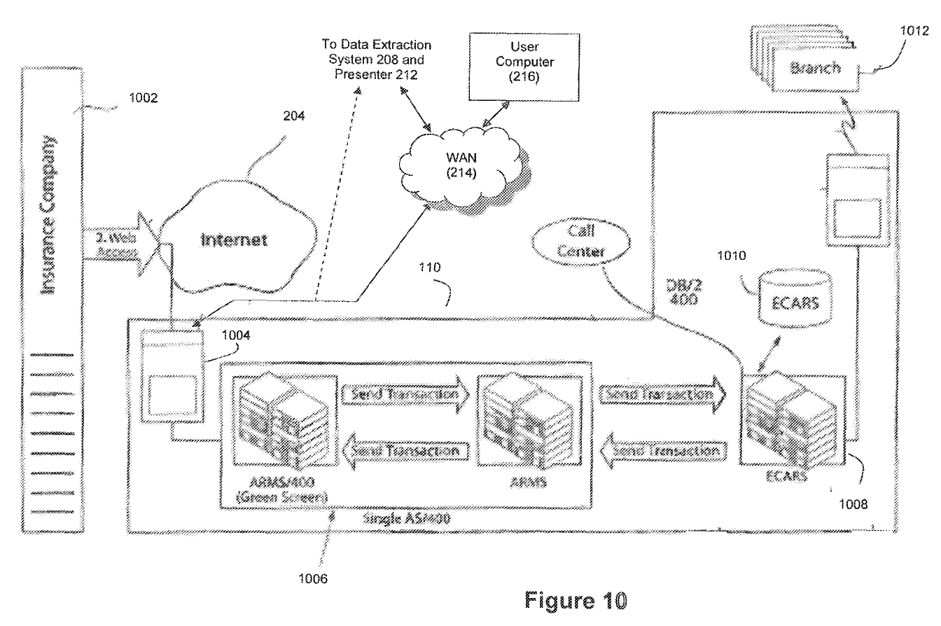

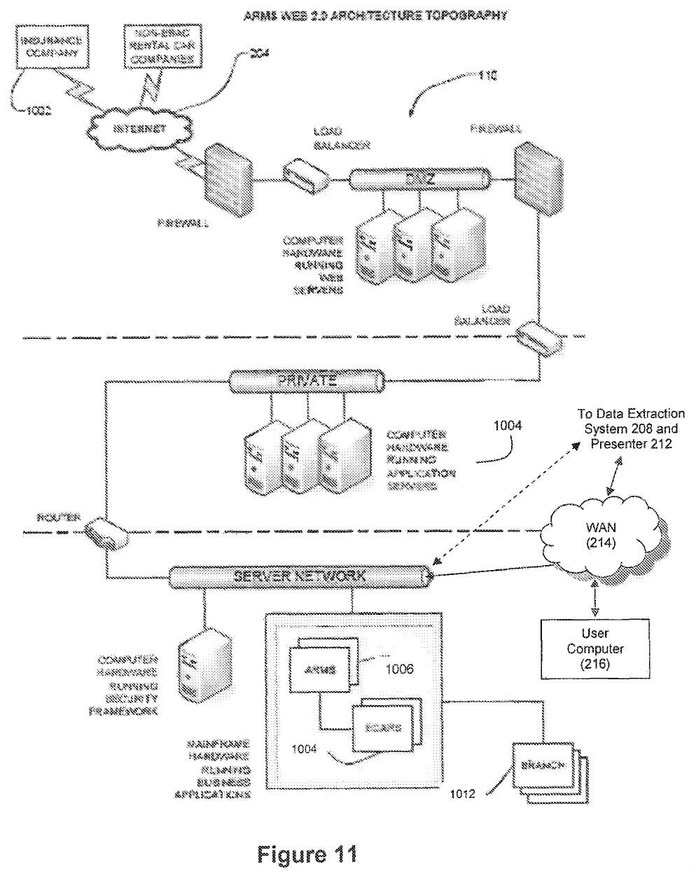

As indicated above, the reservation computer system 110 is preferably an automated rental vehicle reservation management system such as the ARMS system operated by Enterprise. FIGS. 10 and 11 depict exemplary embodiments of an automated rental vehicle reservation management system 110 suitable for use with the present invention. FIG. 10 depicts a first exemplary embodiment of the automated rental vehicle reservation management system 110, described in greater detail in connection with the above-referenced related patent applications. Preferably, system 110 of FIG. 10 is configured to store reservations in accordance with the reservation data that has been communicated thereto following user selection of the “prefill” button 914. To achieve this prefill, a Create Reservation GUI of the automated rental vehicle reservation management system (such as the ones described in the above-referenced patent applications) is preferably generated and displayed on the user computer 216. The data entry fields of this Create Reservation GUI are preferably automatically pre-filled with the reservation data shown in section 908 of GUI 900. The user can then confirm or pend the reservation through the Create Reservation GUI as he/she would for any other reservations created and managed through the automated rental vehicle reservation management system. Once the reservation enters mainframe 1006 of system 110, it can be fulfilled at the appropriate branch location 1012 of the rental car company (using fulfillment software executed by mainframe 1008 and storing reservations in database 1010) when the renter arrives at the branch to pick up his/her replacement rental vehicle.

FIG. 11 depicts a second exemplary embodiment of the automated rental vehicle reservation management system 110, described in greater detail in connection with the above-referenced related patent applications. As with the embodiment of FIG. 10, system 110 of FIG. 11 is configured to allow the user of user computer 216 to display the Create Reservation GUI prefilled with the reservation data in section 908 in response to user selection of the prefill button 914.

It should be noted that the system 100 can also be configured such that upon user selection of the prefill button 914, a reservation is loaded into the automated rental vehicle reservation management system 110 without calling up a Create Reservation GUI.

Thus, by integrating the fax processing system 106 with the automated rental vehicle reservation management system 110 as shown in FIGS. 10 and 11, the preferred embodiment of the present invention is capable of accepting reservations from customers via numerous paths, each path supporting a different form of electronic communications with a purchaser. By providing multiple paths for customer entry into its reservation computer system, a rental vehicle service provider can thereby accommodate the potentially disparate data communication preferences of its customers, all while using a single integrated system to process those reservations. For example, the rental vehicle service provider need only maintain a single computer network for reservation fulfillment that is comprised of the multiple branch office computer systems 1012, a reservation fulfillment mainframe 1008 for access by those branch computers 1012, and a reservation database 1010 for access by the fulfillment mainframe 1008 for storing the reservations to be fulfilled and under fulfillment at the branches. The different branch office computers 1012 are preferably located at the rental vehicle service provider's numerous geographically dispersed branch office locations where vehicles are available for rent. To provide its customers with electronic access to this single computer network, at least two paths for different types of electronic communications can be provided.

Through a first path, which is described in the above-referenced and incorporated related patent applications, a mainframe 1006 is provided, and this mainframe 1006 includes a software program thereon that is configured to interface an authorized purchaser 1002 (such as an insurance company) with the fulfillment mainframe 1008 for the purposes of creating and managing rental vehicle reservations (such management functionality preferably including authorizations for existing reservations, extensions for reservations, authorizations for extensions to reservations, and submitting payments for completed reservations, etc.). Authorized purchasers 1002, using a computer connected to a network 204 such as the Internet, are provided with access to mainframe 1006 through a web portal 1004. Through this web portal 1004, numerous GUIs can be displayed within a web browser running on the purchaser 1002's computer, wherein these GUIs are configured to receive as input a series of commands from purchasers regarding the creation and management of rental vehicle reservations. Based on the commands received from purchasers 1002 through these GUIs, mainframe 1006 accesses the computer network comprising the mainframe 1008, database 1010 and branches 1012 such that database 1010 is updated as appropriate with reservation data. The above-referenced and incorporated related patent applications describe in greater detail the different means by which such a web-enabled data exchange with authorized purchasers can be achieved through the first path.

Through a second path, a fax processing system 106 as described herein is employed to capture requests to create reservations from purchasers and prefill the reservation data corresponding to those requests into a GUI menu accessed through web portal 1004, whereupon mainframe 1006 operates to book a rental vehicle reservation in accordance therewith with the rental vehicle service provider's computer network comprised of mainframe 1008, database 1010 and branch office computers 1012. Thus, purchasers can be provided with at least two choices for creating reservations with a rental vehicle service provider, and wherein the rental vehicle service provider is provided with the ability to harness the power of a single computer network configured for fulfilling reservations to handle the fulfillment end of such reservations. It should also be noted that it is preferred that once a reservation has entered the automated rental vehicle management system 110 via the second path, that such a reservation can be managed by the purchaser via the first path if desired.

Returning to FIG. 9(a), to cancel their work on the fax, users can select the cancel button 910. If the user has successfully prefilled the reservation data into the reservation computer system 110, the user can select the finish button 916 to remove the fax from its queue. Selection of the finish button 916 is also preferably effective to automatically save the fax and its corresponding extracted reservation data in the archive database 210. Also, if the user decides that the fax should be deleted from the system (e.g., it is a fax that was misdirected to the system such as a spam fax), he/she can select the delete button 912. User selection of the “fax file” link 918 is preferably effective to display the original PDF version of the fax image depicted in section 902. From a display of the PDF version, the user can easily save, copy, and/or email the fax as desired.

FIG. 9(b) depicts an exemplary GUI 920 that is displayed following user selection of a fax within the Third Party queue, wherein user interaction with GUI 920 largely mirrors that of GUI 900. In the event the OCR process is unable to read a particular portion of the fax image shown in section 902, then the data field corresponding to that unreadable portion is preferably populated with an indicator 928 (such as a string of question marks) to notify the user that he/she should check the fax image to determine whether appropriate data can be entered in that field.

FIG. 9(c) depicts an exemplary GUI 930 that is displayed following user selection of a fax within the Both Parties queue, wherein user interaction with GUI 930 largely mirrors that of GUIs 900 and 920.

FIG. 9(d) depicts an exemplary GUI 940 that is displayed following user selection of a fax within the No Fault Determination queue. GUI 940 preferably includes a field 942 in which the user can specify the email address of the party to whom the fax image shown in section 902 should be sent via email as a PDF attachment. Through field 944, the user can specify an email address for an additional recipient of the fax image. Upon entry of the appropriate email address(es) in fields 942 and 944, the user can cause such an email to be automatically generated and sent by selecting button 946. The recipient of this email can be an employee who has been tasked with the job of deciding how liability for the insurance claim should be assessed. Upon a determination of liability for the insurance claim, an appropriate reservation in accordance with the extracted reservation data can then be booked with the rental vehicle service provider.

FIG. 9(e) depicts an exemplary GUI 950 that is displayed following user selection of a fax within the Exception queue. The Exception queue is preferably populated with faxes that were either unreadable or could not be classified by the data extraction system 208 into any of the other four categories. For example, the purchaser may have used the incorrect fax form to send the fax, or the fax may include handwriting that is unreadable by the data extraction system 208. Other examples include misdirected faxes or spam faxes that may have been received by system 100. When such an exceptional fax is received by the system, the data extraction system 208 preferably will not populate any of the data fields within section 908. If user review of the fax image in section 902 indicates that the fax does in fact correspond to a reservation request, the user can then manually enter the relevant information from the fax image into the data fields of section 908 (followed by user selection of the prefill button 914 if appropriate).

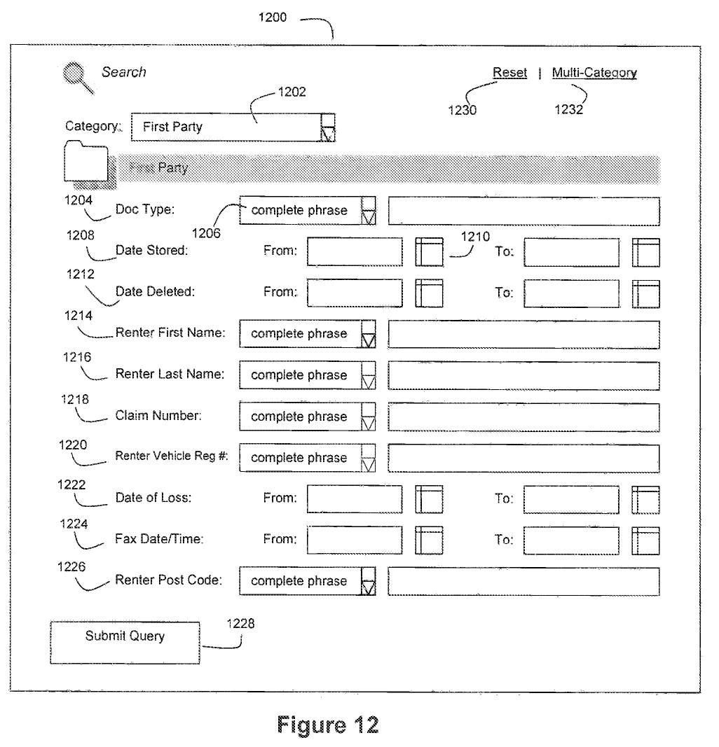

Returning to FIG. 6, once the user has processed a received fax as appropriate through the GUIs of FIGS. 9(a)-(e), then the fax image in section 902 and the reservation data in section 908 is stored in the archive database 210 for subsequent retrieval and processing if necessary (step 616). For example, it may be necessary to later retrieve a particular fax (and its corresponding reservation data) from the database 210 to doublecheck some aspect thereof. To retrieve a particular fax (and its corresponding reservation data) from the database, the user can access a search GUI 1200 as shown in FIG. 12 through the presenter interface 212. GUI 1200 preferably includes a plurality of fields through which the user can specify various searching criteria. For example, GUI 1200 can include a field 1202 through which the user can specify a particular queue in which to search. If the user wants to search in more than one queue, he/she can select the “multi-category” link 1232. Furthermore, through field 1204, the user can specify a document type to be searched (e.g., PDF, TIF, etc.). With dropdown menu 1206 controlling the nature of the search (e.g., whether it is an AND search, an OR search, etc.) based on the criteria specified in field 1204. Through field 1208, the user can specify a date range for when the subject faxes were stored in the database. A calendar icon 1210 can be selected to facilitate the manner by which the user specifies the appropriate dates. Through fields 1214 and 1216, the user can specify the renter's first and/or last name (or partials thereof). Through field 1218, the user can specify a claim number (or partial claim number) applicable to a fax. Through field 1220, the user can specify a vehicle registration number (or partial number) applicable to a fax. Through field 1220, the user can specify a date range for the date of loss applicable to a fax. Through field 1224, the user can specify a date range for the date on which a fax was received by the system, and through field 1226 the user can specify a postal code (or partial postal code) for a renter. After the user has entered whatever search criteria may be appropriate, he/she can select button 1228, whereupon a search of the database 210 is conducted by system 208 to identify whether there are any faxes stored therein that match the specified search criteria. Any results are preferably presented to the user on a GUI in a list from which the user can select the fax(es) for more in-depth review. If the user wants to reset the fields of GUI 1200, he/she can select the “reset” link 1230. Additional functionality that is supported by the use of database 210 is the ability to generate various reports regarding the reservations received and processed via fax.

While the present invention has been described above in relation to its preferred embodiment, various modifications may be made thereto that still fall within the invention's scope, as would be recognized by those of ordinary skill in the art. Such modifications to the invention will be recognizable upon review of the teachings herein. For example, it should be noted that an additional field of data that can be included in and extracted from faxes for facilitating automated reservation creation can be the vehicle type for the reservation (e.g., a compact car, mid-size car, full-size car, etc.). In the absence of such a field in the fax forms, it is preferred that reservations created from faxes default to some predetermined vehicle class, possibly on a per-purchaser default basis. It should also be noted that while the exemplary faxes described herein included only a single reservation request therein, faxes could be used to communicate a batch of reservation requests to the rental vehicle service provider.

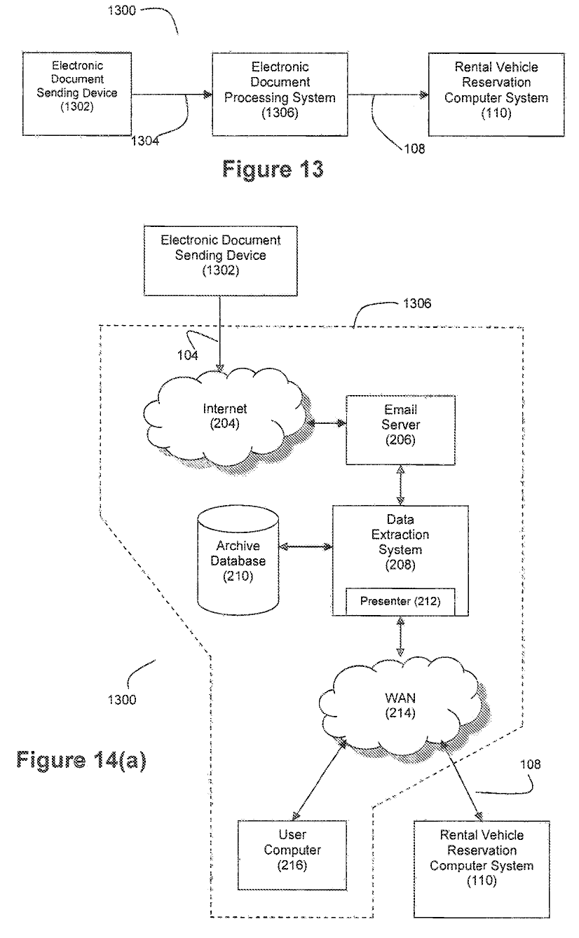

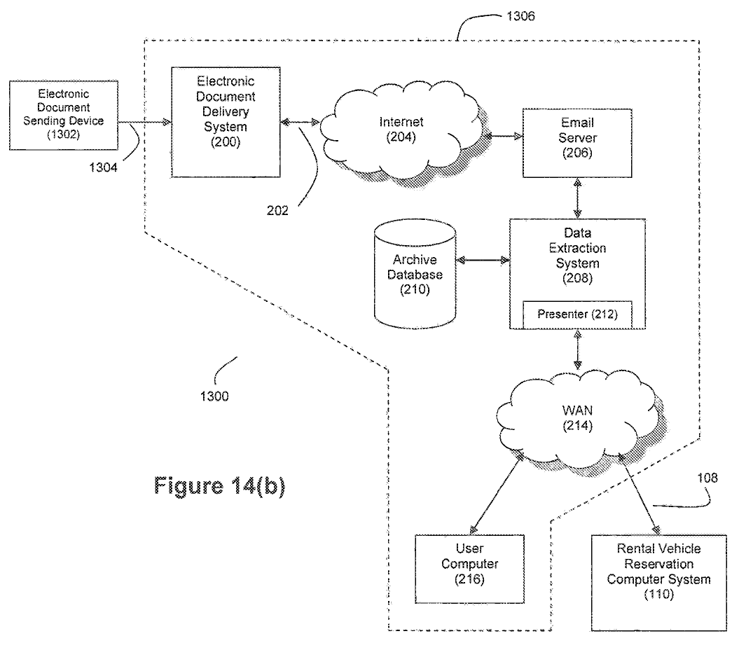

Furthermore, the system 100 can be used to process not only faxes, but also any electronic documents having text that can be parsed to extract relevant reservation data therefrom. Examples of such electronic documents include emails, word processing documents (e.g., Microsoft Word documents), spreadsheet documents (e.g., Microsoft Excel documents, wherein spreadsheet documents could be particularly useful for delivering a batch of rental vehicle reservations into the reservation computer system), and the like. FIG. 13 illustrates a system 1300 that is configured to automatically process electronic documents 1304 from a purchaser to thereby extract reservation data 108 therefrom for loading into a reservation computer system 110. Examples of electronic document sending devices 1302 that can be used in the practice of system 1300 would include a standard PC connected to the Internet that include email sending or document uploading capabilities. As with the fax processing system of the above-described embodiment, the electronic document processing system 1306, as shown in FIGS. 14(a) and (b), is preferably configured to receive the purchaser's electronic document 1304 (e.g., an email itself or an electronic document attached to an email) and automatically extract the text therein corresponding to one or more rental vehicle reservations.

To do so, the arrangement of text within the purchaser's electronic documents preferably follows a format that is known to the data extraction system 208. If desired, a queue-based system can be employed by the data extraction system 208 to manage received electronic documents, as described in the fax-based embodiment above.

In the embodiment of FIG. 14(a), the electronic document 1304 is directly parsed by the data extraction system 208 to extract the reservation data therefrom. In such instances, the data extraction system 208 need not employ OCR.

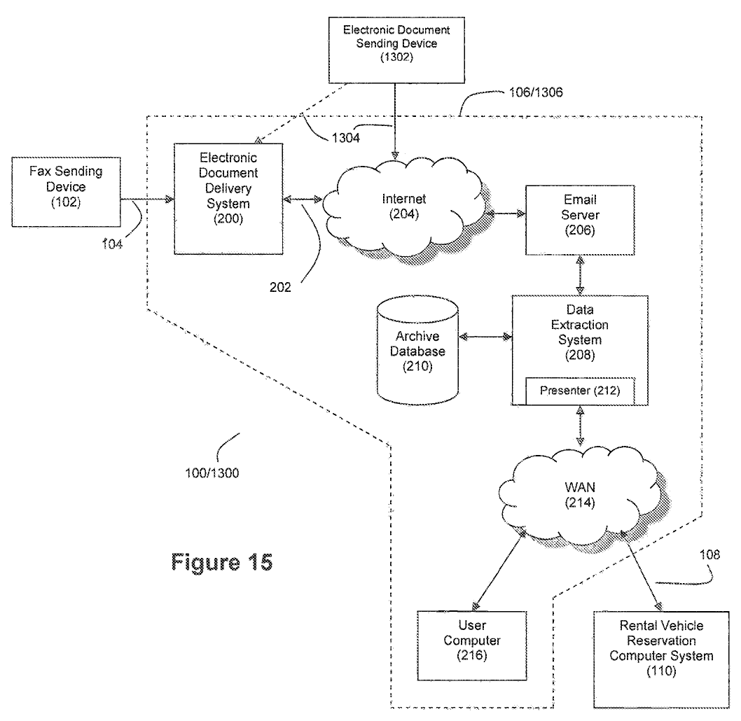

In the embodiment of FIG. 14(b), the electronic document is first converted to an image 202 as discussed above, whereupon processing of the image proceeds as described above for faxes, including the use of OCR. As a still further embodiment illustrated by FIG. 15, the fax processing system 106 and the electronic document processing system 1306 can be combined together such that both faxes and other electronic documents such as emails, word processing documents, spreadsheets and the like can be automatically processed to extract reservation data therefrom.

Also, while the preferred embodiment contemplates that human intervention through the user computer 216 can be used to confirm the correctness of reservation data extracted from the received faxes, it should be noted that system 100 can be implemented without such human intervention, whereby the extracted reservation data is automatically loaded into the reservation system 110 without the confirmatory acts of the user. Further still, a hybrid approach can be taken where only the faxes categorized into an Exception queue are sent for human intervention via user computer 216, with all other faxes and the data extracted therefrom being automatically converted into reservations loaded into system 110 without human intervention. Moreover, the preferred embodiment described herein contemplates that the data extraction system 208 perform OCR and text extraction on documents by matching faxes or other electronic documents to pre-defined recognized templates. It should be noted that the system 100 could also be configured to process free form faxes and electronic documents, wherein an algorithm comprising a set of business rules is employed on the text string extracted from the free form fax to determine what reservation data is contained therein. Should such a free form fax be unreadable or incomplete with respect to the reservation data contained therein, it could be categorized as an exception and forwarded on for human intervention.

Further still, while the examples of FIGS. 10 and 11 show that the fax processing system can be configured to communicate extracted reservation data to mainframe 1006 of the automated rental vehicle reservation management system via web portal 1004, it should be noted that fax processing system can alternatively be configured to communicate the extracted reservation data directly to the mainframe 1006, mainframe 1008 or database 1010 if desired by a practitioner of the invention. Any of a variety of interconnection architectures can be employed to link the fax processing system 106/electronic document processing system 1306 to the reservation computer system. For example, optionally the data extraction system 208 can be in communication with the reservation computer system 110 as shown by the dashed lines in FIGS. 10 and 11.

As such, the full scope of the present invention is to be defined solely by the appended claims and their legal equivalents.

What is claimed is:

1. A system for creating a rental vehicle reservation from an electronic document communication, the system comprising:
a reservation computer system that is configured to store and process rental vehicle reservations placed with a rental vehicle service provider;
an electronic document processing system in communication with the reservation computer system, the electronic document processing system being configured to receive an electronic document, the electronic document corresponding to a request by a purchaser to reserve a rental vehicle and including therein reservation data that defines the rental vehicle reservation, wherein the electronic document processing system is further configured to automatically extract the reservation data from the electronic document in a format that is readable by the reservation computer system and communicate the extracted reservation data to the reservation computer system to thereby book a rental vehicle reservation.

2. The system of claim 1 wherein the electronic document comprises a facsimile and wherein the electronic document processing system comprises a fax processing system.

3. The system of claim 2 wherein the fax processing system is further configured to extract the reservation data from the facsimile via optical character recognition (OCR).

4. The system of claim 3 wherein the fax processing system comprises:
an electronic document delivery system that is configured to receive the facsimile and convert the received facsimile into an electronic document of a predetermined format; and
a data extraction system that is configured to receive the electronic document generated by the electronic document delivery system and perform OCR on the received electronic document to extract the reservation data therefrom.

5. The system of claim 4 wherein the data extraction system comprises a presenter interface, and wherein the fax processing system further comprises:
a user computer that is configured to access the electronic document and the extracted reservation data through at least one graphical user interface (GUI) available to the user computer via the presenter interface, wherein the GUI is configured to allow a user of the user computer to control whether the reservation data is loaded into the reservation computer system to create the rental vehicle reservation therewith.

6. The system of claim 5 wherein the data extraction system is further configured to sort each received electronic document into at least one of a plurality of predefined categories, and wherein the presenter interface is configured to provide a plurality of GUIs for access by the user computer and through which the user can access reservations sorted into the user-selected categories.

7. The system of claim 6 wherein the reservation computer system comprises an automated rental vehicle reservation management system.

8. The system of claim 6 wherein the fax processing system further comprises an email server configured to (1) receive a plurality of emails from the electronic document delivery system, wherein each email includes as an attachment thereto the electronic document corresponding to the received facsimile and (2) deliver the electronic documents attached to the emails to the data extraction system.

9. The system of claim 6 wherein the fax processing system further comprises a database in which the electronic documents are stored, and wherein the presenter interface is further configured to provide at least one GUI for access by the user computer and through which the user can search for electronic documents stored in the database based on a user-specified search criteria.

10. The system of claim 4 wherein the facsimile has a predetermined format, and wherein the data extraction system is further configured to perform OCR on the received electronic document based on the predetermined format to extract the reservation data therefrom.

11. The system of claim 4 wherein the facsimile has any of a plurality of different predetermined formats, and wherein the data extraction system is further configured to (1) perform OCR on the received electronic document to identify which of the predetermined formats is applicable thereto and (2) perform additional OCR on the received electronic document based on the identified predetermined format to extract the reservation data therefrom.

12. The system of claim 11 wherein at least a plurality of the different predetermined formats correspond to facsimile formats for different purchasers, and wherein the data extraction system is further configured to (1) maintain a plurality of OCR processing profiles for the plurality of different purchasers, (2) and retrieve the OCR processing profile for the purchaser corresponding to the identified predetermined format, and (3) perform the additional OCR on the received electronic document based on the retrieved OCR processing profile to extract the reservation data therefrom.

13. The system of claim 3 wherein the facsimile includes a plurality of rental vehicle reservation requests therein, and wherein the fax processing system is configured to extract reservation data for the plurality of reservation requests from the facsimile.

14. The system of claim 1 wherein the electronic document comprises an email.

15. The system of claim 1 wherein the electronic document comprises a word processing document.

16. The system of claim 1 wherein the electronic document comprises a spreadsheet.

17. The system of claim 16 wherein the spreadsheet includes a plurality of rental vehicle reservation requests therein, and wherein the electronic document processing system is further configured to extract reservation data corresponding to the plurality of reservation requests from the spreadsheet.

18. A computer-implemented method for creating rental vehicle reservations from electronic document communications, the method comprising:
receiving an electronic document from a purchaser in an electronic format, the electronic document corresponding to a request for a rental vehicle reservation and including therein reservation data that defines the requested rental vehicle reservation;
automatically processing the electronic document with computer software to extract the reservation data therefrom; and
loading the extracted reservation data into a reservation computer system to thereby book a rental vehicle reservation with a rental vehicle service provider.

19. The method of claim 18 wherein the electronic document comprises a facsimile.

20. The method of claim 19 wherein the automatically processing step comprises performing optical character recognition (OCR) on the facsimile to extract the reservation data therefrom.

21. The method of claim 20 wherein the facsimile has a predetermined format, and wherein the OCR performing step comprises performing OCR on the facsimile based on the predetermined format to extract the reservation data therefrom.

22. The method of claim 21 wherein the loading step comprises loading the extracted reservation data into the reservation computer system in response to a user input through a graphical user interface (GUI).

23. The method of claim 22 further comprising automatically populating the GUI with the extracted reservation data.

24. The method of claim 23 further comprising providing the user with the ability to modify the extracted reservation data through the GUI prior to loading that reservation data into the reservation computer system.

25. The method of claim 23 wherein the facsimile has a predetermined format that is selected from a plurality of available predetermined formats, the method further comprising:
performing OCR on the facsimile to recognize which predetermined format is applicable to the facsimile.

26. The method of claim 25 further comprising sorting the facsimile into a queue based on the recognized predetermined format.

27. The method of claim 26 further comprising providing a second GUI for access by the user and through which the user can select the queue in which to retrieve and process facsimiles.

28. The method of claim 27 wherein a plurality of the facsimiles correspond to different purchasers, the method further comprising:
maintaining a plurality of OCR processing profiles, each OCR processing profile corresponding to a purchaser;
determining the purchaser applicable to a facsimile based on the recognized predetermined format; and
performing OCR on the facsimile to extract the reservation data therefrom based on the OCR processing profile of the determined purchaser.

29. The method of claim 20 further comprising converting the facsimile to a TIF image prior to performing OCR thereon.

30. The method of claim 20 wherein the facsimile comprises a plurality of requests for a plurality of rental vehicle reservations, and wherein the loading step comprises loading the extracted reservation data into a reservation computer system to thereby book a plurality of rental vehicle reservations with a rental vehicle service provider.

31. The method of claim 19 wherein the purchaser comprises a business organization.

32. The method of claim 31 wherein the business organization comprises a business organization having a recurring need to book a plurality of replacement rental vehicle reservations.

33. The method of claim 32 wherein the business organization comprises an insurance company.

34. The method of claim 33 further comprising:
providing a second path through which reservations can be loaded into the reservation computer system, the second path comprising an Internet connection between the reservation computer system and a computer of a second purchaser;
electronically communicating non-facsimile data regarding a reservation from the second purchaser to the reservation computer system to thereby book a rental vehicle reservation with the reservation computer system.

35. The method of claim 18 wherein the electronic document comprises an email.

36. The method of claim 18 wherein the electronic document comprises a word processing document.

37. The method of claim 18 wherein the electronic document comprises a spreadsheet.

38. The method of claim 37 wherein the spreadsheet comprises a plurality of requests for a plurality of rental vehicle reservations, and wherein the loading step comprises loading the extracted reservation data into a reservation computer system to thereby book a plurality of rental vehicle reservations with a rental vehicle service provider.

39. The method of claim 18 wherein the automatically processing step comprises converting the electronic document into an image and performing optical character recognition (OCR) on the image to extract the reservation data therefrom.

40. A system for creating and managing a plurality of rental vehicle reservations, the system comprising:
a computer network comprising a plurality of branch office computers, a first mainframe in communication with the plurality of branch office computers and configured to execute a fulfillment software program upon request by a branch office computer when a rental vehicle reservation is to be fulfilled, and a database in communication with the first mainframe for storing data regarding a plurality of rental vehicle reservations for fulfillment via the fulfillment software program;
a second mainframe in communication with the computer network;
a web portal in communication with the Internet and the second mainframe, the web portal being configured to interface a first authorized purchaser with the second mainframe via a plurality of graphical user interfaces (GUIs) that are presented by the web portal for display within a web browser of an Internet-connected computer that is under operation of the first authorized purchaser, the plurality of GUIs being configured to accept as input thereto a series of commands from the first authorized purchaser for creating and managing rental vehicle reservations; and
an electronic document processing system in communication with the second mainframe, the electronic document processing system being configured to accept as input thereto an electronic document from a second authorized purchaser, the electronic document corresponding to a request for a rental vehicle reservation and including reservation data therein, and wherein the electronic document processing system is further configured to automatically extract the reservation data from the electronic document and communicate the extracted reservation data to the second mainframe; and
wherein the second mainframe is configured to execute a rental vehicle software program, the rental vehicle software program being configured to (1) create and manage a plurality of the reservations stored in the database in response to the input from the first authorized purchaser, and (2) create a reservation for storage in the database based on the extracted reservation data.

41. The system of claim 40 wherein the electronic document comprises a facsimile and wherein the electronic document processing system comprises a fax processing system.

42. The system of claim 41 wherein the fax processing system is configured to automatically extract the reservation data from the facsimile via optical character recognition (OCR) software.

43. The system of claim 40 wherein the electronic document comprises at least one selected from the group consisting of an email, a word processing document and a spreadsheet document.

44. A system for creating and managing a plurality of rental vehicle reservations, the system comprising:
a computer network comprising a plurality of branch office computers, a first mainframe in communication with the plurality of branch office computers and configured to execute a fulfillment software program upon request by a branch office computer when a rental vehicle reservation is to be fulfilled, and a database in communication with the first mainframe for storing data regarding a plurality of rental vehicle reservations for fulfillment via the fulfillment software program;
a second mainframe in communication with the computer network;
a web portal in communication with the Internet and the second mainframe, the web portal being configured to interface a first authorized purchaser with the second mainframe via a plurality of graphical user interfaces (GUIs) that are presented by the web portal for display within a web browser of an Internet-connected computer that is under operation of the first authorized purchaser, the plurality of GUIs being configured to accept as input thereto a series of commands from the first authorized purchaser for creating and managing rental vehicle reservations; and
an electronic document processing system in communication with the computer network, the electronic document processing system being configured to accept as input thereto an electronic document from a second authorized purchaser, the electronic document corresponding to a request for a rental vehicle reservation and including reservation data therein, and wherein the electronic document processing system is further configured to automatically extract the reservation data from the electronic document and communicate the extracted reservation data to the computer network to thereby create a reservation that is stored in the database; and
wherein the second mainframe is configured to execute a rental vehicle software program, the rental vehicle software program being configured to create and manage a plurality of the reservations stored in the database in response to the input from the first authorized purchaser.

45. The system of claim 44 wherein the electronic document comprises a facsimile and wherein the electronic document processing system comprises a fax processing system.

46. The system of claim 45 wherein the fax processing system is further configured to communicate the extracted reservation data to the first mainframe to thereby create a reservation that is to be stored in the database.

47. The system of claim 45 wherein the fax processing system is further configured to communicate the extracted reservation data to the database to thereby create a reservation that is to be stored in the database.

48. The system of claim 44 wherein the electronic document comprises at least one selected from the group consisting of an email, a word processing document and a spreadsheet document.
